(19) United States
(12) Patent Application Publication
(10) Pub. No.: US 2026/0290684 A1
(43) Pub. Date: Sep. 24, 2026

(54) MULTILAYER COIL COMPONENT

(71) Applicant: TDK Corporation, Tokyo (JP)

(72) Inventors: Yusuke NAGAI, Tokyo (JP); Kazuhiro EBINA, Tokyo (JP); Takahiro SATO, Tokyo (JP); Makoto YOSHINO, Tokyo (JP); Shin TSUKAMOTO, Tokyo (JP); Takumi ITO, Tokyo (JP)

(73) Assignee: TDK Corporation, Tokyo (JP)

(21) Appl. No.: 19/569,107

(22) Filed: Mar. 17, 2026

(30) Foreign Application Priority Data
Mar. 21, 2025 (JP) 2025-046574

(51) Int. Cl. H01F 37/00; H01F 27/00; H01F 27/29

(52) U.S. Cl. CPC H01F 37/005; H01F 27/006; H01F 27/29

(57) ABSTRACT

A multilayer coil component includes an element body including a plurality of magnetic layers laminated in a first direction, and a coil having a coil axis along the first direction and disposed inside the element body. The coil includes a plurality of coil conductors arranged in the first direction and directly connected to each other. The plurality of coil conductors have a first coil conductor and a second coil conductor adjacent to each other in the first direction. When viewed from the first direction, a first circumferential angle at which the first coil conductor extends around the coil axis is equal to a second circumferential angle at which the second coil conductor extends around the coil axis.

### TECHNICAL FIELD

The present disclosure relates to a multilayer coil component. This application claims priority based on Japanese Patent Application No. 2025-046574 filed on Mar. 2, 2025, the entire contents of which are incorporated herein by reference.

### BACKGROUND

Japanese Unexamined Patent Publication No. 2003-37012 describes a multilayer inductor including an element body and a coil disposed inside the element body. In this multilayer inductor, a plurality of coil conductors are connected through conductor-filled through holes.

### SUMMARY

The coil described in Japanese Unexamined Patent Publication No. 2003-37012 lacks smoothness in coil shape compared to a wound coil formed by winding a wire. For this reason, it is difficult to improve winding efficiency. Further, since magnetic flux tends to concentrate, it is difficult to improve DC superposition characteristics.

The present disclosure aims to improve the winding efficiency and DC superposition characteristics of a coil.

(1) A multilayer coil component according to an aspect of the present disclosure includes an element body including a plurality of magnetic layers laminated in a first direction, and a coil having a coil axis along the first direction and disposed inside the element body, wherein the coil includes a plurality of coil conductors arranged in the first direction and directly connected to each other, the plurality of coil conductors have a first coil conductor and a second coil conductor adjacent to each other in the first direction, and when viewed from the first direction, a first circumferential angle at which the first coil conductor extends around the coil axis is equal to a second circumferential angle at which the second coil conductor extends around the coil axis.

In the above multilayer coil component, since the plurality of coil conductors are directly connected to each other, the shape of the coil can be made closer to the shape of a wound coil compared to a configuration in which a plurality of coil conductors are connected via conductors such as through hole conductors. Since the first circumferential angle of the first coil conductor is equal to the second circumferential angle of the second coil conductor, the shape of the coil can be made further closer to the shape of a wound coil. Therefore, improvement of the winding efficiency and DC superposition characteristics of the coil is possible.

(2) In the multilayer coil component described in the above (1), when viewed from the first direction, circumferential angles at which the plurality of coil conductors extend around the coil axis may all be equal. In this case, since the shape of the coil can be made further closer to the shape of a wound coil, further improvement of the winding efficiency and DC superposition characteristics of the coil is possible.

(3) In the multilayer coil component described in the above (2), when a number of coil conductors until a same pattern shape is repeated among the plurality of coil conductors is n (where n is a natural number of 3 or more), and the circumferential angle is θ(°), 360°/n<θ<360°×(n−1)/n may be satisfied. In this case, by satisfying 360°/n<θ, a continuous coil can be constituted by the coil conductors. By satisfying θ<360°×(n−1)/n, the coil can be constituted by a portion consisting of one coil conductor, or a portion formed by directly connecting two or more and (n−1) or less (there is a range because it depends on the circumferential angle) coil conductors to each other, without providing a portion formed by directly connecting n coil conductors to each other (substantially not becoming a shape like a through hole conductor). Therefore, the winding efficiency of the coil can be further improved.

(4) In the multilayer coil component described in the above (2) or (3), each of the plurality of coil conductors includes an overlap region overlapping with a coil conductor adjacent in the first direction when viewed from the first direction, and when viewed from the first direction, overlap angles at which the plurality of overlap regions extend around the coil axis may all be equal. In this case, since the shape of the coil can be made further closer to the shape of a wound coil, further improvement of the winding efficiency and DC superposition characteristics of the coil is possible.

(5) In the multilayer coil component described in any one of the above (1) to (4), when viewed from the first direction, lengths of the plurality of coil conductors may all be equal. In this case, since the shape of the coil can be made further closer to the shape of a wound coil, further improvement of the winding efficiency and DC superposition characteristics of the coil is possible.

(6) In the multilayer coil component described in any one of the above (1) to (5), a longitudinal direction of the element body may coincide with the first direction. In this case, the number of turns of the coil can be increased.

(7) The multilayer coil component described in any one of the above (1) to (6) further includes a pair of connecting conductors connected to both ends of the coil, wherein the element body includes a pair of end surfaces facing away from each other in the first direction, and a side surface extending in the first direction so as to connect the pair of end surfaces, and the pair of connecting conductors may be exposed from the side surface. In this case, if the side surface where the pair of connecting conductors are exposed is used as a mounting surface, external electrodes can be provided only on the mounting surface.

(8) In the multilayer coil component described in any one of the above (1) to (7), each of the plurality of coil conductors may have a flat shape over an entire length. In this case, concentration of magnetic flux is suppressed compared to a configuration in which the coil conductor includes a step.

(9) In the multilayer coil component described in any one of the above (1) to (8), when viewed from the first direction, the plurality of coil conductors may be arranged so as to rotate in one direction by a constant angle around the coil axis as going from a first end to a second end of the coil. In this case, since the shape of the coil can be made further closer to the shape of a wound coil, further improvement of the winding efficiency and DC superposition characteristics of the coil is possible.

(10) In the multilayer coil component described in any one of the above (1) to (9), both end surfaces of the plurality of coil conductors may be inclined with respect to the first direction. In this case, occurrence of cracks originating from both end surfaces of the coil conductor can be suppressed.

### BRIEF DESCRIPTION OF THE DRAWINGS

FIG. 1 is a perspective view of a multilayer coil component according to a first embodiment.

FIG. 2 is an exploded perspective view showing a layer configuration of the multilayer coil component of FIG. 1.

FIG. 3A, FIG. 3B, and FIG. 3C are plan views showing pattern shapes of coil conductors.

FIG. 4 is an exploded perspective view showing a layer configuration of a multilayer coil component according to a second embodiment.

FIG. 5A, FIG. 5B, and FIG. 5C are plan views showing pattern shapes of coil conductors according to a first modification.

FIG. 6A, FIG. 6B, FIG. 6C, and FIG. 6D are plan views showing pattern shapes of coil conductors according to a second modification.

FIG. 7A, FIG. 7B, FIG. 7C, and FIG. 7D are plan views showing pattern shapes of coil conductors according to a third modification.

FIG. 8A, FIG. 8B, and FIG. 8C are cross-sectional views for explaining end surfaces of coil conductors.

### DETAILED DESCRIPTION

Hereinafter, embodiments of the present disclosure will be described in detail with reference to the accompanying drawings. In the description of the drawings, the same or corresponding elements are denoted by the same reference numerals, and redundant description will be omitted.

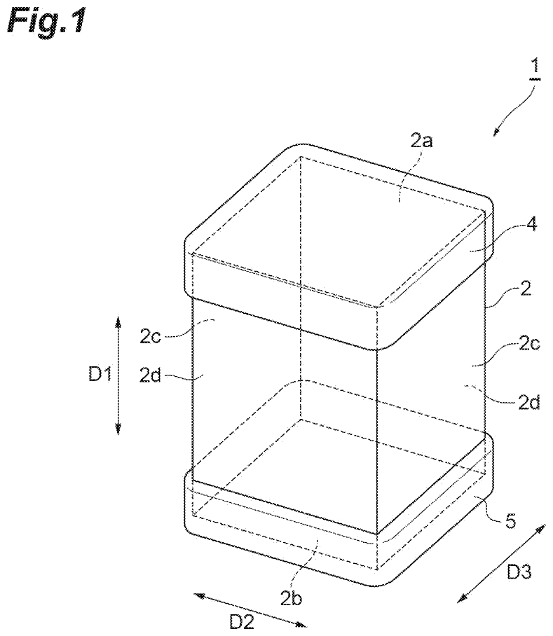

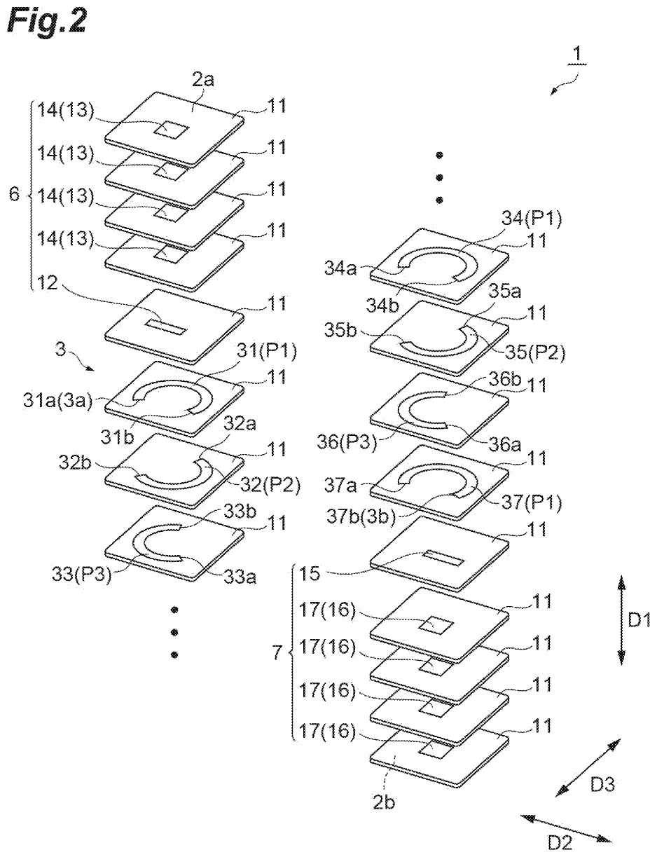

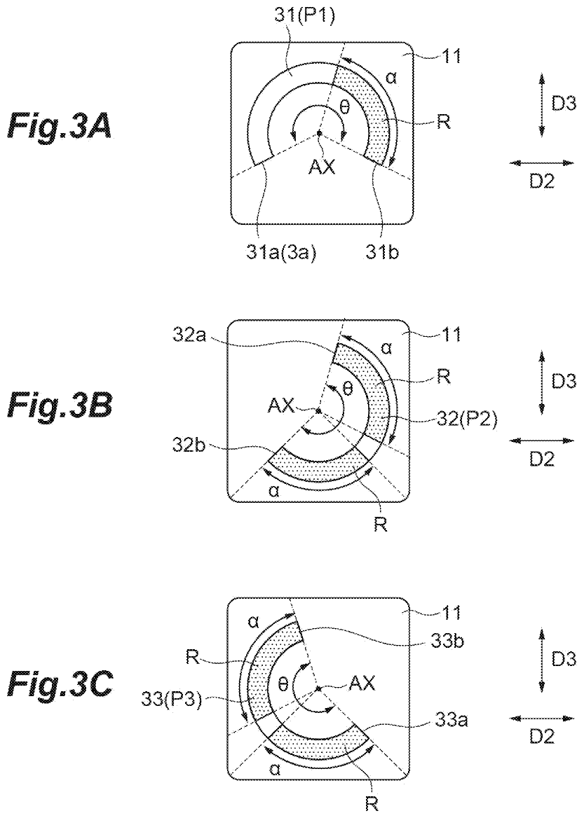

(First Embodiment) A multilayer coil component 1 according to a first embodiment will be described with reference to FIG. 1, FIG. 2, FIG. 3A, FIG. 3B, and FIG. 3C. As shown in these figures, the multilayer coil component 1 includes an element body 2, a coil 3, an external electrode 4, an external electrode 5, a connecting conductor 6, and a connecting conductor 7. The coil 3, the connecting conductor 6, and the connecting conductor 7 are internal conductors and are disposed inside the element body 2. In FIG. 2, illustration of the external electrode 4 and the external electrode 5 is omitted. The multilayer coil component 1 is applicable to, for example, a bead inductor or a power inductor.

The element body 2 has a rectangular parallelepiped shape. The rectangular parallelepiped shape includes a shape of a rectangular parallelepiped in which corners and ridge lines are chamfered, and a shape of a rectangular parallelepiped in which corners and ridge lines are rounded. The element body 2 includes an end surface 2a and an end surface 2b facing away from each other, a pair of side surfaces 2c facing away from each other, and a pair of side surfaces 2d facing away from each other, as outer surfaces of the element body 2.

The end surface 2a and the end surface 2b face away from each other in a first direction D1. The pair of side surfaces 2c face away from each other in a second direction D2. The pair of side surfaces 2d face away from each other in a third direction D3. The pair of side surfaces 2c and the pair of side surfaces 2d extend in the first direction D1 so as to connect the end surface 2a and the end surface 2b to each other. The first direction D1, the second direction D2, and the third direction D3 intersect (are orthogonal in the present embodiment) each other.

A longitudinal direction of the element body 2 coincides with the first direction D1. A length of the element body 2 in the first direction D1 is, for example, 0.1 mm or more and 3.5 mm or less. A length of the element body 2 in the second direction D2 and a length of the element body 2 in the third direction D3 are shorter than the length of the element body 2 in the first direction D1, are, for example, equivalent to each other, and are, for example, 0.05 mm or more and 2.5 mm or less. The length of the element body 2 in the second direction D2 and the length of the element body 2 in the third direction D3 may be equal to or greater than the length of the element body 2 in the first direction D1. The length of the element body 2 in the second direction D2 may be shorter or longer than the length of the element body 2 in the third direction D3.

One side surface 2c is, for example, a surface (mounting surface) facing an electronic device when the multilayer coil component 1 is mounted on the electronic device (not shown). The electronic device includes, for example, a circuit board or an electronic component. The end surface 2a, the end surface 2b, and the pair of side surfaces 2d are surfaces adjacent to the side surface 2c, respectively. The first direction D1 and the third direction D3 are directions along the side surface 2c, respectively. The second direction D2 is a direction intersecting (orthogonal in the present embodiment) the side surface 2c.

The element body 2 includes a plurality of magnetic layers 11 laminated in the first direction D1. A lamination direction of the plurality of magnetic layers 11 is the first direction D1. The element body 2 is configured by laminating the plurality of magnetic layers 11 in the first direction D1. In the actual element body 2, the plurality of magnetic layers 11 are integrated to such an extent that boundaries between the layers cannot be visually recognized.

The magnetic layer 11 includes a plurality of metal magnetic particles. The metal magnetic particles are composed of, for example, a soft magnetic alloy. The soft magnetic alloy is, for example, an Fe—Si based alloy. When the soft magnetic alloy is an Fe—Si based alloy, the soft magnetic alloy may include P. The soft magnetic alloy may be, for example, an Fe—Ni—Si-M based alloy. “M” includes one or more elements selected from Co, Cr, Mn, P, Ti, Zr, Hf, Nb, Ta, Mo, Mg, Ca, Sr, Ba, Zn, B, Al, and rare earth elements.

The element body 2 includes a resin. The resin exists between the plurality of metal magnetic particles. The resin is a resin having electrical insulation properties (insulating resin). The insulating resin includes, for example, a silicone resin, a phenol resin, an acrylic resin, or an epoxy resin.

The external electrode 4 and the external electrode 5 are disposed at both ends of the element body 2 in the first direction D1. The external electrode 4 and the external electrode 5 are separated from each other in the first direction D1. The external electrode 4 is disposed at an end of the element body 2 on the end surface 2a side. The external electrode 5 is disposed at an end of the element body 2 on the end surface 2b side. The external electrode 4 and the external electrode 5 include a conductive material. The conductive material is, for example, Ag or Pd. The external electrode 4 and the external electrode 5 are configured as a sintered body of a conductive paste. The conductive paste includes conductive metal powder and glass frit. The conductive metal powder is, for example, Ag powder or Pd powder. A plating layer is formed on surfaces of the external electrode 4 and the external electrode 5. The plating layer is formed by, for example, electroplating. The electroplating is, for example, electro Ni plating or electro Sn plating.

The external electrode 4 includes five electrode portions disposed on the end surface 2a, the pair of side surfaces 2c, and the pair of side surfaces 2d. The five electrode portions are integrally formed. The electrode portion located on the end surface 2a covers the entire surface of the end surface 2a. The electrode portion located on the side surface 2c covers a part of the side surface 2c. The electrode portion located on the side surface 2d covers a part of the side surface 2d.

The external electrode 5 includes five electrode portions disposed on the end surface 2b, the pair of side surfaces 2c, and the pair of side surfaces 2d. The five electrode portions are integrally formed. The electrode portion located on the end surface 2b covers the entire surface of the end surface 2b. The electrode portion located on the side surface 2c covers a part of the side surface 2c. The electrode portion located on the side surface 2d covers a part of the side surface 2d.

The coil 3 is disposed inside the element body 2 apart from the outer surfaces of the element body 2. The coil 3 is disposed apart from the end surface 2a and the end surface 2b by an equal distance. When viewed from the first direction D1, the coil 3 is disposed apart from the pair of side surfaces 2c and the pair of side surfaces 2d by an equal distance. The coil 3 has a coil axis AX along the first direction D1. The coil axis AX is orthogonal to the end surface 2a and the end surface 2b. The coil axis AX extends along the pair of side surfaces 2c and the pair of side surfaces 2d. The coil axis AX coincides with a central axis of the element body 2 and is disposed so as to pass through a center of gravity of the element body 2. The coil 3 includes a first end 3a connected to the connecting conductor 6, and a second end 3b connected to the connecting conductor 7.

The coil 3 includes coil conductors 31 to 37 connected to each other. The coil 3 is configured by connecting the coil conductors 31 to 37 in this order. Each of the coil conductors 31 to 37 includes first ends 31a to 37a located closer to the first end 3a side than the second end 3b, and second ends 31b to 37b located closer to the second end 3b side than the first end 3a. The first ends 31a to 37a and the second ends 31b to 37b are, for example, end surfaces extending in the first direction D1.

The coil conductors 31 to 37 are arranged in the first direction D1 inside the element body 2. Among the coil conductors 31 to 37, the coil conductor 31 is disposed closest to the end surface 2a, and the coil conductor 37 is disposed closest to the end surface 2b. The first end 31a of the coil conductor 31 constitutes the first end 3a of the coil 3. The second end 37b of the coil conductor 37 constitutes the second end 3b of the coil 3. The coil conductors 31 to 37 are directly connected to each other without interposing conductors such as through hole conductors.

The coil conductor 31 and the coil conductor 32 are adjacent to each other in the first direction D1. The coil conductor 32 and the coil conductor 33 are adjacent to each other in the first direction D1. The coil conductor 33 and the coil conductor 34 are adjacent to each other in the first direction D1. The coil conductor 34 and the coil conductor 35 are adjacent to each other in the first direction D1. The coil conductor 35 and the coil conductor 36 are adjacent to each other in the first direction D1. The coil conductor 36 and the coil conductor 37 are adjacent to each other in the first direction D1.

Each of the coil conductors 31 to 37 includes an overlap region R overlapping with a coil conductor adjacent in the first direction D1 when viewed from the first direction D1, and is directly connected to the coil conductor at the overlap region R. The coil conductor 31 includes one overlap region R, and is directly connected to the coil conductor 32 at the overlap region R. The coil conductor 32 includes two overlap regions R, and is directly connected to the coil conductor 31 and the coil conductor 33 at the respective overlap regions R. The coil conductor 33 includes two overlap regions R, and is directly connected to the coil conductor 32 and the coil conductor 34 at the respective overlap regions R.

Although illustration is omitted, the coil conductor 34 includes two overlap regions R, and is directly connected to the coil conductor 33 and the coil conductor 35 at the respective overlap regions R. The coil conductor 35 includes two overlap regions R, and is directly connected to the coil conductor 34 and the coil conductor 36 at the respective overlap regions R. The coil conductor 36 includes two overlap regions R, and is directly connected to the coil conductor 35 and the coil conductor 37 at the respective overlap regions R. The coil conductor 37 includes one overlap region R, and is directly connected to the coil conductor 36 at the overlap region R.

The coil conductors 31 to 37 have three pattern shapes P1 to P3 when viewed from the first direction D1. The coil conductor 31, the coil conductor 34, and the coil conductor 37 have the pattern shape P1. The coil conductor 32 and the coil conductor 35 have the pattern shape P2. The coil conductor 33 and the coil conductor 36 have the pattern shape P3. In the coil 3, the pattern shapes P1 to P3 are repeated in this order from the first end 3a toward the second end 3b.

The pattern shapes P1 to P3 of the present embodiment have 120° (3-fold) rotational symmetry centered on the coil axis AX. Three consecutive coil conductors correspond to a set of the pattern shapes P1 to P3, and form one turn of the coil 3. One turn of the coil 3 is a portion until the same pattern shape is repeated in the coil 3 formed by repetition of pattern shapes. In the present embodiment, when viewed from the first direction D1, the coil 3 has an annular shape. The pattern shapes P1 to P3 have a fan-like arc shape centered on the coil axis AX. Central angles of the fan shapes corresponding to the pattern shapes P1 to P3 are all equal. In this specification, “equal” does not necessarily mean only that values match. Even if a minute difference within a preset range, a manufacturing error, or a measurement error is included in the value, the values may be considered equal. For example, if a plurality of values are included within a range of ±5% of an average value of the plurality of values, the plurality of values are defined as equal.

In other words, when viewed from the first direction D1, circumferential angles at which the coil conductors 31 to 37 extend around the coil axis AX are all equal. The circumferential angle is an angle formed by both ends of each of the coil conductors 31 to 37 and the coil axis AX when viewed from the first direction D1, and is an angle of a region where each of the coil conductors 31 to 37 is disposed. When the circumferential angle is θ (°) and the number of coil conductors until the same pattern shape is repeated is n (where n is a natural number of 3 or more), Formula (1) is satisfied. 360°/n<θ<360°×(n−1)/n (1) In the present embodiment, n=3. Therefore, θ satisfies 120°<θ<240°. θ is, for example, 220°.

When viewed from the first direction D1, lengths of the coil conductors 31 to 37 are all equal. Here, the length of each of the coil conductors 31 to 37 is a length by which each of the coil conductors 31 to 37 extends around the coil axis AX when viewed from the first direction D1, and is a length by which each of the coil conductors 31 to 37 extends in a direction orthogonal to the first direction D1. When viewed from the first direction D1, widths of the coil conductors 31 to 37 are all equal. Thicknesses (maximum lengths in the first direction D1) of the coil conductors 31 to 37 are all equal. Each of the coil conductors 31 to 37 is provided so as to penetrate one corresponding magnetic layer 11, and has the same thickness as the magnetic layer 11.

Each of the coil conductors 31 to 37 has a flat shape over an entire length. No step in the first direction D1 is formed between both ends of each of the coil conductors 31 to 37. A pair of side surfaces of each of the coil conductors 31 to 37 facing in the first direction D1 are both formed of planes without steps. Each of the coil conductors 31 to 37 is disposed at the same height position in the first direction D1 over the entire length. Both ends of each of the coil conductors 31 to 37 are disposed at the same height position in the first direction D1.

The connecting conductor 6 includes a conductor portion 12 extending in the second direction D2, and a conductor portion 13 extending in the first direction D1. The conductor portion 12 is composed of one conductor layer. One end of the conductor portion 12 is connected to the first end 3a of the coil 3. The other end of the conductor portion 12 is connected to one end of the conductor portion 13. The conductor portion 13 extends in the first direction D1 by laminating a plurality of conductor layers 14 of the same shape in the first direction D1. When viewed from the first direction D1, the plurality of conductor layers 14 overlap with the conductor portion 12. The other end of the conductor portion 13 is exposed from the end surface 2a.

The connecting conductor 7 includes a conductor portion 15 extending in the second direction D2, and a conductor portion 16 extending in the first direction D1. The conductor portion 15 is composed of one conductor layer. One end of the conductor portion 15 is connected to the second end 3b of the coil 3. The other end of the conductor portion 15 is connected to one end of the conductor portion 16. The conductor portion 16 extends in the first direction D1 by laminating a plurality of conductor layers 17 of the same shape in the first direction D1. When viewed from the first direction D1, the plurality of conductor layers 17 overlap with the conductor portion 15. The other end of the conductor portion 16 is exposed from the end surface 2b.

When viewed from the first direction D1, overlap angles α(°) at which the overlap regions R of the coil conductors 31 to 37 extend around the coil axis AX are all equal. The overlap angle α is, for example, ½ or less of the circumferential angle θ. In the present embodiment, the overlap angle α is 100°. Note that an overlap angle αₙ₋₁(°) when (n−1) coil conductors overlap is represented by

$${α}_{n - 1} = ( 4 \times 18 {0}^{∘} ) / n - 2 \times 180 ° + θ$$

and a range of θ (°) where αₙ₋₁ holds is as follows:

$$\frac{n - 2}{n} \times 360 ° < θ$$

When viewed from the first direction D1, the coil conductors 31 to 37 are arranged so as to rotate in one direction (here, a clockwise direction when viewed from the end surface 2a side) by a constant angle around the coil axis AX as going from the first end 3a to the second end 3b of the coil 3. In the present embodiment, the constant angle is 120° (=360°/n). The object rotating in this way may be the entirety of the coil conductors 31 to 37, may be the first ends 31a to 37a, or may be the second ends 31b to 37b.

The coil conductors 31 to 37, the connecting conductor 6, and the connecting conductor 7 include a conductive material (for example, Ag or Pd). The coil conductors 31 to 37, the connecting conductor 6, and the connecting conductor 7 are configured as a sintered body of a conductive paste including a conductive material (for example, Ag powder or Pd powder).

As described above, in the multilayer coil component 1, since the coil conductors 31 to 37 are directly connected to each other at the overlap regions R, the shape of the coil 3 can be made closer to the shape of a wound coil compared to a configuration in which a plurality of coil conductors are connected via conductors such as through hole conductors. Further, when viewed from the first direction D1, the circumferential angles θ at which the coil conductors 31 to 37 extend around the coil axis AX are all equal. When viewed from the first direction D1, the overlap angles α at which the plurality of overlap regions R extend around the coil axis AX are all equal. When viewed from the first direction D1, the lengths of the coil conductors 31 to 37 are all equal. When viewed from the first direction D1, the coil conductors 31 to 37 are arranged so as to rotate in one direction by a constant angle around the coil axis AX as going from the first end 3a to the second end 3b of the coil 3. From these facts, the shape of the coil 3 can be made further closer to the shape of a wound coil. Therefore, since concentration of magnetic flux is suppressed, improvement of DC superposition characteristics is possible. Further, improvement of winding efficiency of the coil 3 is possible.

Theoretical formulas of inductor performance are premised on a wound coil. In a multilayer coil component, since a plurality of coil conductors are connected to form a coil, the shape of the coil differs from the shape of a wound coil, and as a result, inductor performance may not match a theoretical value. Therefore, in a multilayer coil component, it is difficult to improve characteristics of the coil. On the other hand, in the multilayer coil component 1 of the present embodiment, the shape of the coil 3 can be made closer to the shape of a wound coil. Therefore, the inductor performance easily matches the theoretical value, and design becomes easy, and as a result, improvement of characteristics of the coil 3 is possible.

In the multilayer coil component 1, the circumferential angle θ and the number of coil conductors n satisfy the above Formula (1). By satisfying 360°/n<0, the continuous coil 3 can be constituted by the coil conductors 31 to 37 without interruption. By satisfying 0<360°× (n−1)/n, the coil 3 can be constituted by a portion consisting of one coil conductor, or a portion formed by directly connecting two coil conductors to each other, without providing a portion formed by directly connecting three or more coil conductors to each other. Therefore, the winding efficiency of the coil 3 can be further improved.

In the multilayer coil component 1, each of the coil conductors 31 to 37 has a flat shape over the entire length. For this reason, concentration of magnetic flux is suppressed compared to a case where each of the coil conductors 31 to 37 includes a step. Further, since the length of each of the coil conductors 31 to 37 in the first direction D1 becomes shorter compared to the case where each of the coil conductors 31 to 37 includes a step, the winding efficiency of the coil 3 is improved.

In the multilayer coil component 1, the longitudinal direction of the element body 2 coincides with the first direction D1. Since the coil axis AX of the coil 3 also coincides with the first direction D1, the number of turns of the coil 3 can be increased.

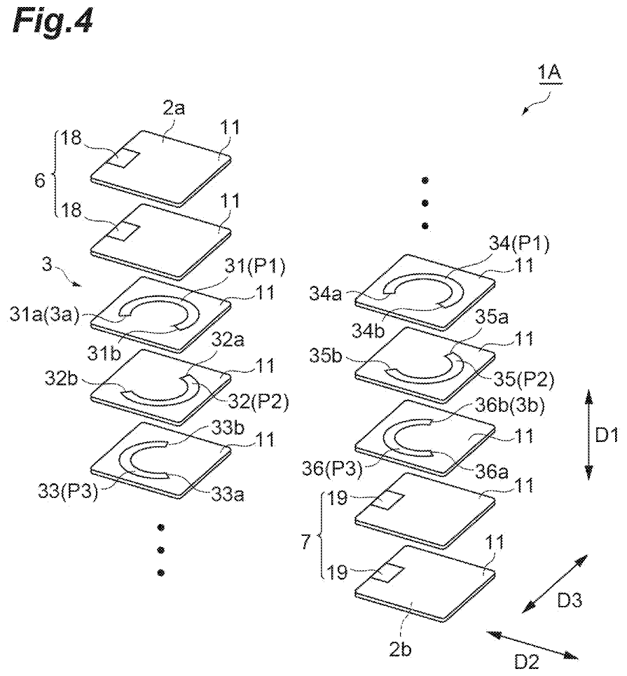

(Second Embodiment) A multilayer coil component 1A according to a second embodiment will be described with reference to FIG. 4. As shown in the figure, the multilayer coil component 1A differs from the multilayer coil component 1 according to the first embodiment in that the connecting conductor 6 and the connecting conductor 7 are exposed from one side surface 2c. In the multilayer coil component 1A, the connecting conductor 6 is exposed from the end surface 2a and the one side surface 2c. The connecting conductor 6 extends in the first direction D1 by laminating a plurality of conductor layers 18 of the same shape in the first direction D1. The connecting conductor 7 is exposed from the end surface 2b and the one side surface 2c. The connecting conductor 7 extends in the first direction D1 by laminating a plurality of conductor layers 19 of the same shape in the first direction D1. In this modification, the conductor layer 18 and the conductor layer 19 have the same shape as each other, and are arranged so as to overlap with each other when viewed from the first direction D1.

The multilayer coil component 1A differs from the multilayer coil component 1 also in that the coil 3 does not have the coil conductor 37. In the multilayer coil component 1A, the second end 36b of the coil conductor 36 constitutes the second end 3b of the coil 3. The multilayer coil component 1A has the same configuration as the multilayer coil component 1 in other points. Also in the multilayer coil component 1A, similarly to the multilayer coil component 1, improvement of the winding efficiency and DC superposition characteristics of the coil 3 is possible.

In the multilayer coil component 1A, the element body 2 may further have magnetic layers 11 serving as cover layers at both ends in the first direction D1. No conductor layer is provided in the cover layer. In this case, since the connecting conductor 6 and the connecting conductor 7 are covered with the cover layers and are not exposed from the end surface 2a and the end surface 2b, they are exposed only from the one side surface 2c serving as a mounting surface. Therefore, the external electrode 4 and the external electrode 5 can be provided only on the mounting surface. Thereby, a mounting area when the multilayer coil component 1A is solder-mounted on an electronic device can be reduced.

Although the embodiments have been described above, the present invention is not necessarily limited to the above-described embodiments, and various modifications are possible without departing from the gist thereof.

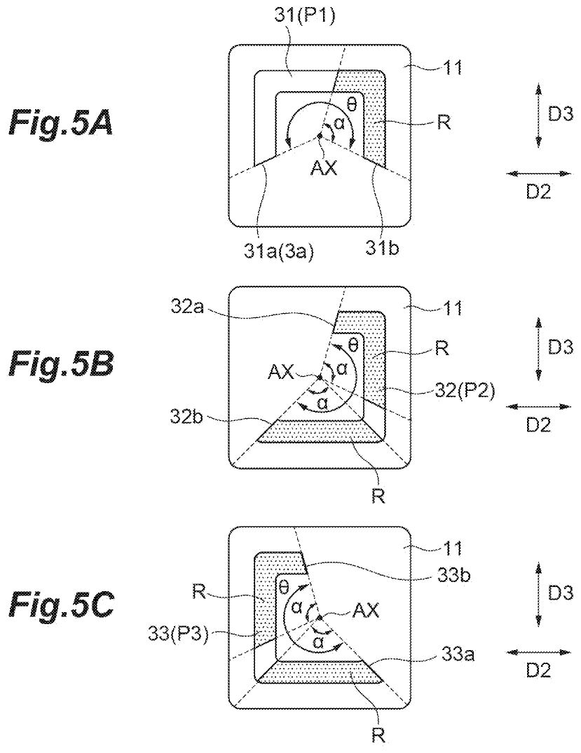

(First Modification) FIG. 5A, FIG. 5B, and FIG. 5C are plan views showing pattern shapes of coil conductors according to a first modification. As shown in the figures, the multilayer coil component according to this modification differs from the multilayer coil component 1 according to the first embodiment in that the coil has a rectangular annular shape when viewed from the first direction D1, and the coil conductors 31 to 37 have a shape forming a part of a rectangular ring, but has the same configuration as the multilayer coil component 1 in other points. Although illustration of the plurality of coil conductors 34 to 37 is omitted, the coil conductor 34 and the coil conductor 37 have the same pattern shape P1 as the coil conductor 31, the coil conductor 35 has the same pattern shape P2 as the coil conductor 32, and the coil conductor 36 has the same pattern shape P3 as the coil conductor 33.

Also in this modification, the coil conductors 31 to 37 are directly connected to each other at the overlap regions R without interposing conductors such as through hole conductors. The circumferential angles θ of the coil conductors 31 to 37 are all equal, and the above Formula (1) is satisfied. The overlap angles α of the coil conductors 31 to 37 are all equal. Each of the coil conductors 31 to 37 has a flat shape over the entire length. Also in this modification, similarly to the multilayer coil component 1, improvement of the winding efficiency and DC superposition characteristics of the coil is possible.

In this modification, the pattern shapes P1 to P3 do not have rotational symmetry, but may have rotational symmetry. When viewed from the first direction D1, the coil conductors 31 to 37 are arranged such that the first ends 31a to 37a or the second ends 31b to 37b rotate in one direction by a constant angle around the coil axis AX as going from the first end 3a to the second end 3b of the coil 3. Also in this modification, further improvement of the winding efficiency and DC superposition characteristics of the coil is possible.

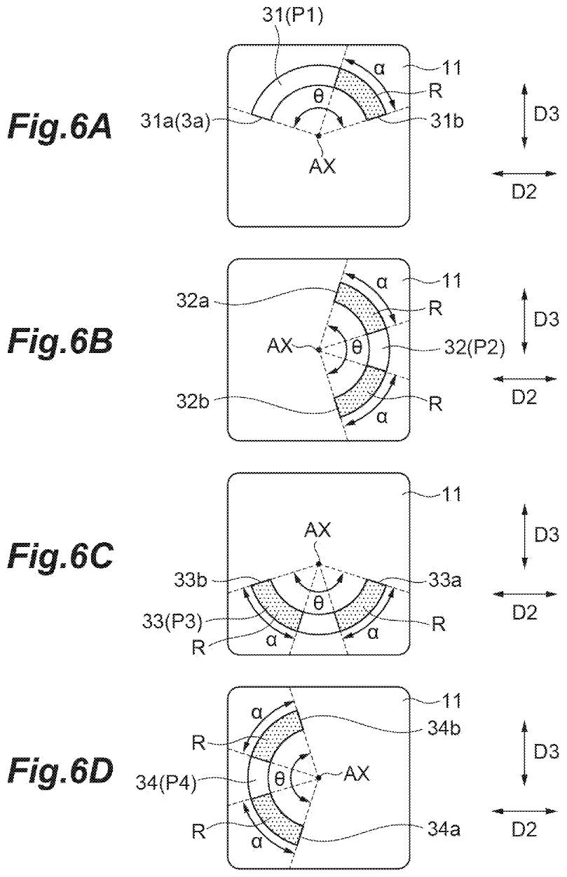

(Second Modification) FIG. 6A, FIG. 6B, FIG. 6C, and FIG. 6D are exploded plan views showing a part of a layer configuration of a multilayer coil component according to a second modification. As shown in the figures, in the multilayer coil component according to this modification, the number of coil conductors until the same pattern shape is repeated is 4, and the coil conductors 31 to 37 have four pattern shapes P1 to P4 when viewed from the first direction D1. The pattern shapes P1 to P4 have 90° (4-fold) rotational symmetry centered on the coil axis AX. In this modification, since n=4, θ satisfies 90°<θ<270°. Although illustration is omitted, the coil conductor 35 may have the pattern shape P1, the coil conductor 36 may have the pattern shape P2, and the coil conductor 37 may have the pattern shape P3. In this modification, the configuration is the same as that of the multilayer coil component 1 in other points.

Also in this modification, the coil conductors 31 to 37 are directly connected to each other at the overlap regions R without interposing conductors such as through hole conductors. The circumferential angles θ of the coil conductors 31 to 37 are all equal, and the above Formula (1) is satisfied. The overlap angles α of the coil conductors 31 to 37 are all equal, and are, for example, 70°. Each of the coil conductors 31 to 37 has a flat shape over the entire length. Also in this modification, similarly to the multilayer coil component 1, improvement of the winding efficiency and DC superposition characteristics of the coil is possible.

The pattern shapes P1 to P4 of this modification have rotational symmetry. When viewed from the first direction D1, the coil conductors 31 to 37 are arranged so as to rotate in one direction by a constant angle around the coil axis AX as going from the first end to the second end of the coil. Also in this modification, further improvement of the winding efficiency and DC superposition characteristics of the coil is possible.

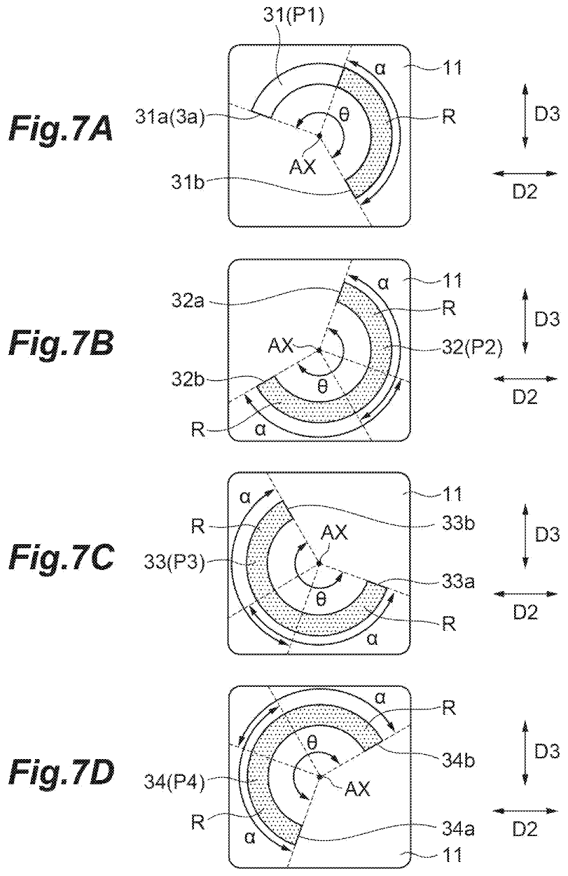

(Third Modification) FIG. 7A, FIG. 7B, FIG. 7C, and FIG. 7D are exploded plan views showing a part of a layer configuration of a multilayer coil component according to a third modification. As shown in the figures, the multilayer coil component according to this modification differs from the multilayer coil component according to the second modification in that 0 is larger than 180° and is 220°. Also in this modification, the coil conductors 31 to 37 are directly connected to each other at the overlap regions R without interposing conductors such as through hole conductors. The circumferential angles θ of the coil conductors 31 to 37 are all equal, and the above Formula (1) is satisfied. The overlap angles α for two layers of the coil conductors 31 to 37 are all equal, and are, for example, 130°. Each of the coil conductors 31 to 37 has a flat shape over the entire length. Also in this modification, similarly to the multilayer coil component 1, improvement of the winding efficiency and DC superposition characteristics of the coil is possible.

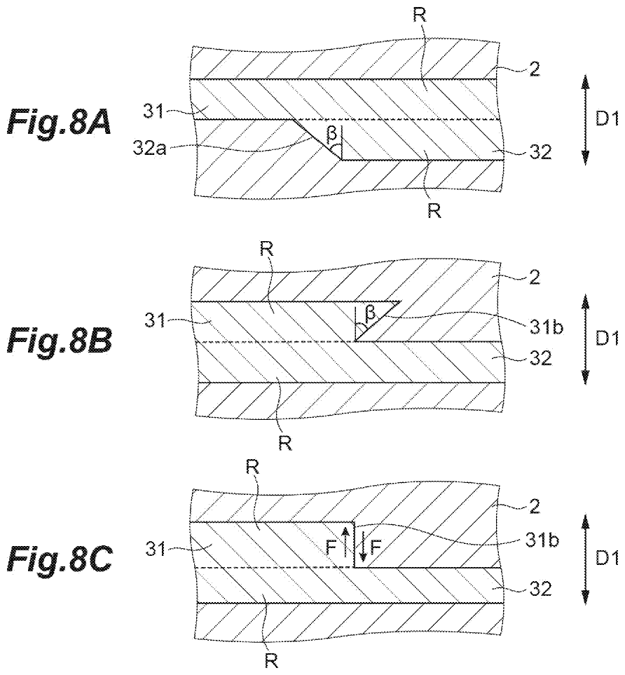

(Fourth Modification) FIG. 8A and FIG. 8B are cross-sectional views of a multilayer coil component according to a fourth modification. As shown in the figures, in the multilayer coil component according to the fourth modification, the second end 31b (end surface) of the coil conductor 31 and the first end 32a (end surface) of the coil conductor 32 are inclined surfaces inclined with respect to the first direction D1. Although illustration of end surfaces other than the second end 31b and the first end 32a is omitted, the multilayer coil component according to this modification differs from the multilayer coil component 1 in that the first ends 31a to 37a and the second ends 31b to 37b are inclined surfaces inclined with respect to the first direction D1. Inclination angles β (°) of the inclined surfaces are, for example, all equal and are 45° or less.

In this modification, among a pair of side surfaces of each of the coil conductors 31 to 37 facing in the first direction D1, a side surface located closer to the end surface 2a has a larger area than a side surface located closer to the end surface 2b, and overlaps with each of the first ends 31a to 37a and each of the second ends 31b to 37b when viewed from the first direction D1. FIG. 8C is a cross-sectional view of the multilayer coil component according to the first embodiment. As shown in the figure, in the multilayer coil component 1, the second end 31b is an end surface parallel to the first direction D1. The second end 31b constitutes an interface with the element body 2. When a shear stress F in the first direction D1 is applied to the multilayer coil component 1, a crack originating from this interface is likely to occur in the element body 2. On the other hand, in this modification, since the interface is inclined, occurrence of cracks can be suppressed.

The above embodiments and the above modifications may be combined as appropriate.

What is claimed is:

1. A multilayer coil component comprising:
an element body including a plurality of magnetic layers laminated in a first direction; and
a coil having a coil axis along the first direction and disposed inside the element body,
wherein the coil includes a plurality of coil conductors arranged in the first direction and directly connected to each other,
the plurality of coil conductors have a first coil conductor and a second coil conductor adjacent to each other in the first direction, and
when viewed from the first direction, a first circumferential angle at which the first coil conductor extends around the coil axis is equal to a second circumferential angle at which the second coil conductor extends around the coil axis.

2. The multilayer coil component according to claim 1, wherein when viewed from the first direction, circumferential angles at which the plurality of coil conductors extend around the coil axis are all equal.

3. The multilayer coil component according to claim 2, wherein when a number of coil conductors until a same pattern shape is repeated among the plurality of coil conductors is n that is a natural number of 3 or more, and the circumferential angle is θ(°),
360°/n<θ<360°×(n−1)/n
is satisfied.

4. The multilayer coil component according to claim 2, wherein each of the plurality of coil conductors includes an overlap region overlapping with a coil conductor adjacent in the first direction when viewed from the first direction, and
when viewed from the first direction, overlap angles at which the plurality of overlap regions extend around the coil axis are all equal.

5. The multilayer coil component according to claim 1, wherein when viewed from the first direction, lengths of the plurality of coil conductors are all equal.

6. The multilayer coil component according to claim 1, wherein a longitudinal direction of the element body coincides with the first direction.

7. The multilayer coil component according to claim 1, further comprising a pair of connecting conductors connected to both ends of the coil,
wherein the element body includes a pair of end surfaces facing away from each other in the first direction, and a side surface extending in the first direction so as to connect the pair of end surfaces, and
the pair of connecting conductors are exposed from the side surface.

8. The multilayer coil component according to claim 1, wherein each of the plurality of coil conductors has a flat shape over an entire length.

9. The multilayer coil component according to claim 1, wherein when viewed from the first direction, the plurality of coil conductors are arranged so as to rotate in one direction by a constant angle around the coil axis as going from a first end to a second end of the coil.

10. The multilayer coil component according to claim 1, wherein both end surfaces of the plurality of coil conductors are inclined with respect to the first direction.
